(19) United States
(12) Patent Application Publication
(10) Pub. No.: US 2007/0174241 A1
(43) Pub. Date: Jul. 26, 2007

(54) Match graphs for query evaluation

(76) Inventors: Kevin S. Beyer, San Jose, CA (US); Vanja Josifovski, Los Gatos, CA (US); Edison L. Ting, San Jose, CA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/336,022

(22) Filed: Jan. 20, 2006

(51) Int. Cl. G06F 17/30

(52) U.S. Cl. 707/3

(57) ABSTRACT

Provided are techniques for processing a query. The query is received, and the query is formed by one or more paths, where each path includes one or more steps. A hierarchical document is received that includes one or more document nodes. While processing the query and traversing the hierarchical document to find document nodes described by at least one of the one or more steps of the query, a match graph is constructed that includes one or more match nodes. Each of the match nodes identifies a step instance and is associated with step instances that are ancestors and descendants of the identified step instance. Also, each of the match nodes is associated with a level. In addition, the match graph includes zero or more edges between the match nodes indicating relationships between the match nodes. The match nodes in the match graph are traversed from lower levels to higher levels to construct results for the query.

### BACKGROUND

1. Field

Embodiments of the invention relate to match graphs for query evaluation.

2. Description of the Related Art

Extensible Markup Language (XML) may be described as a flexible text format. XML is a formal recommendation from the World Wide Web Consortium (W3C). XML contains markup symbols to describe the contents of a document. In particular, XML describes the content in terms of what data is being described. Thus, an XML document may be processed as data by a program or may be stored with similar data. XML is “extensible” in that the markup symbols are self-defining. XML is a subset of the Standard Generalized Markup Language (SGML), which is a standard for how to create a document structure.

XML Path Language (XPath) is a language that describes a way to locate and process items in XML documents by using an addressing syntax based on a path through the logical structure or hierarchy of the document. That is, XPath is a language for addressing parts of an XML document.

XML Query (XQuery) provides query facilities to extract data from documents and collections. XQuery is a specification for a query language that allows a user or programmer to extract information from an XML document or any collection of data that is similar in structure to an XML document.

XQuery makes use of XPath. In XQuery, XPath expressions may be simple queries or parts of larger queries.

Notwithstanding existing techniques for processing XML queries, there is a need in the art for improved processing of XML queries.

### SUMMARY OF EMBODIMENTS OF THE INVENTION

Provided are a method, computer program product, and system for processing a query. The query is received, and the query is formed by one or more paths, where each path includes one or more steps. A hierarchical document is received that includes one or more document nodes. While processing the query and traversing the hierarchical document to find document nodes described by at least one of the one or more steps of the query, a match graph is constructed that includes one or more match nodes. Each of the match nodes identifies a step instance and is associated with step instances that are ancestors and descendants of the identified step instance. Also, each of the match nodes is associated with a level. In addition, the match graph includes zero or more edges between the match nodes indicating relationships between the match nodes. The match nodes in the match graph are traversed from lower levels to higher levels to construct results for the query.

### BRIEF DESCRIPTION OF THE DRAWINGS

Referring now to the drawings in which like reference numbers represent corresponding parts throughout:

FIG. 1 illustrates details of a computing device in accordance with certain embodiments;

FIG. 2 illustrates a document, a query, and a query structure in accordance with certain embodiments;

FIG. 3 illustrates a hierarchical document and a query with FOR bindings in accordance with certain embodiments;

FIG. 4 illustrates building of a match graph in accordance with certain embodiments;

FIG. 5 illustrates results of processing a query with FOR bindings using a match graph in accordance with certain embodiments;

FIG. 6 illustrates a hierarchical document and a query with LET bindings in accordance with certain embodiments;

FIG. 7 illustrates building of a match graph with LET match nodes in accordance with certain embodiments;

FIG. 8 illustrates results of processing a query with LET bindings using a match graph in accordance with certain embodiments;

FIG. 9 illustrates logic performed by a query processor in accordance with certain embodiments; and

FIG. 10 illustrates a system architecture that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

Embodiments evaluate a query (e.g., an XQuery) using information in a graph (also referred to as a match graph herein). A graph may be described as a set of nodes connected by edges, with each of the edges describing a relation between two nodes, and with each edge being capable of being bi-directional. Although each edge is capable of being bi-directional, some or all of the edges may be uni-directional (e.g., pointing from an ancestor to a descendant).

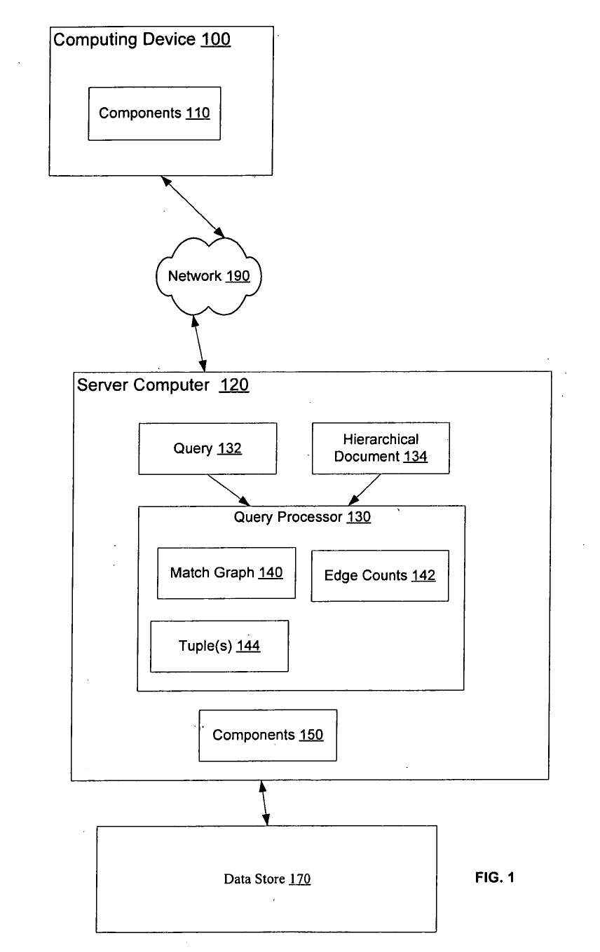

FIG. 1 illustrates details of a computing device in accordance with certain embodiments. A client computer 100 is connected via a network 190 to a server computer 120. The client computer 100 includes components 110 (e.g., one or more client applications).

The server computer 120 includes a query processor 130 and may include one or more additional components 150 (e.g., server applications). The server computer 120 is coupled to a data store 170.

The query processor 130 receives a query 132 (e.g., an XQuery) and a hierarchical document 134 (e.g., an XML document) as input. A query 132 may be described as being formed by one or more paths, where each path includes one or more steps (e.g., for a query having the form /a//b[e]//c, “/a” is a step in the query). A hierarchical document 134 may be described as including one or more document nodes. During processing of the query 132 with reference to the hierarchical document 134, the query processor 130 builds a match graph 140 that includes match nodes. Each match node represents a step instance (i.e., a document node in the hierarchical document 134 that is described by one or more steps in the query 132) and maintains an edge count 142 for each match node. The edge count may be described as identifying a number of ancestors and descendants associated with an associated step instance. The query processor 130 uses the match graphs 140 and the edge counts 142 to construct one or more tuples 144, which form the results of processing the query 132 with reference to the hierarchical document 134.

In certain embodiments, a match graph 140 includes an array of match nodes for each binding in a query 132 (e.g., for a query 132 having the form /a//b/c, the match graph 140 includes an array of match nodes for the “/a” binding, an array of match nodes for the “//b” binding, and an array of match nodes for the “/c” binding). That is, each match node is associated with a binding. Each binding is associated with a level in the match graph. Thus, each match node is associated with a level in the match graph (e.g., a match node for the “/a” binding is associated with level 1, a match node for the “//b” binding is associated with level 2, etc.). A match node may be described as representing an instance of a document node described by a step in a query 132 (i.e., a step instance). For example, for the “/a” binding, there may be multiple match nodes for the array of match nodes associated with the “/a” binding. A binding may be described as a variable that represents a step instance.

In certain embodiments, each match node identifies a step instance and is associated with step instances that are descendants and ancestors of the identified step instance. In certain embodiments, each match node represents a step instance and is associated with an array of step instances that are descendants and ancestors of the identified step instance. In certain alternative embodiments, structures other than an array may be used (e.g., a linked list).

A hierarchical document 134 may be described as being composed of nodes that are related to each other. The top-most node is called a root node, and the root node is the only node that has no parent. A node may have one or more child nodes, also referred to as children. Nodes without child nodes are called leaf nodes. Ancestor nodes may be described as the nodes between a particular node and the root node. Descendant nodes of a particular node may be described as the nodes which have that particular node as an ancestor node.

Embodiments are applicable to any query language that uses paths. A path in a query describes a path of traversal to get to one or more nodes to be returned when the query is applied to a hierarchical document. A path for a particular node in a hierarchical document may be described as one or more sequences of nodes in the hierarchical document that reach the particular node and are along the path described in the query. In certain embodiments, the hierarchical document 134 is an XML document. In certain embodiments, the query 132 is an XQuery made up of one or more XPaths.

While finding document nodes of a hierarchical document that are described by one or more steps of the query, the query processor 130 remembers the document nodes and relationships between these document nodes in a match graph 140. When it is time to return results, the query processor 130 traverses the match graph 140 and returns results as complete sets of match nodes to be extracted are visited. The structural information of the hierarchical document 134 captured in the match graph 140 makes it convenient to reconstruct and return results for the query 132.

The client computer 100 and server computer 120 may comprise any computing device known in the art, such as a server, mainframe, workstation, personal computer, hand held computer, laptop telephony device, network appliance, etc.

The network 190 may comprise any type of network, such as, for example, a peer-to-peer network, spoke and hub network, Storage Area Network (SAN), a Local Area Network (LAN), Wide Area Network (WAN), the Internet, an Intranet, etc.

The data store 170 may comprise an array of storage devices, such as Direct Access Storage Devices (DASDs), Just a Bunch of Disks (JBOD), Redundant Array of Independent Disks (RAID), virtualization device, etc.

Although examples herein may refer to XML documents, XQueries, and/or XPaths, it is to be understood that embodiments are not limited to such examples.

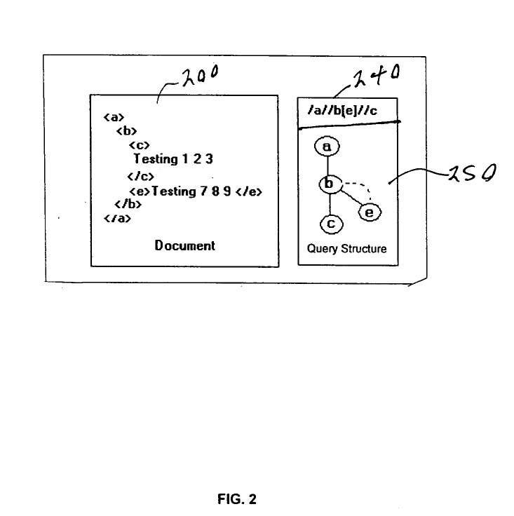

FIG. 2 illustrates a hierarchical document 200, a query 240, and a query structure 250 in accordance with certain embodiments. In certain embodiments, the hierarchical document 200 is an XML document. The hierarchical document is well-formed in that for each open tag (e.g., an <a> document node), there is a corresponding close tag (e.g., a </a> document node). In the hierarchical document 200, an <a> document node has one child <b> document node, and the <b> document node has two children: <c> and <e> document nodes. Also, the <c> and <e> document nodes do not have children.

A query structure may be described as a representation of a query. In FIG. 2, query structure 250 represents query 240, which is /a//b[e]//c. Query 240 indicates that all <c> document nodes are to be returned where the <c> document nodes are descendants of all the <b> document nodes, where the <b> document nodes have an immediate child <e> document node, and the <b> document nodes are under <a> document nodes. For purposes of illustration, in the queries, double slashes (“//”) following a step (e.g., a//) are used to represent any descendant of a particular node or the node itself in a path (i.e., a descendants axis), while single slashes (“/”) are used to represent the child axis. For example, a//b indicates that a <b> document node may be at any level below an <a> document node in the hierarchical document 200. Also, in the queries, brackets (“[ ]”) following a node test represent a predicate to be applied to the node test. For example, in FIG. 2, [e] is a predicate. The query structure 250 depicts that the query processor 130 is looking for <b> document nodes that are descendants of (not just children of)<a> document nodes and that “b” is a child of “a” and an ancestor of “c” and “e”. The dashed line between “b” and “e” represents that the “e” step is part of a predicate.

A path (e.g., an XPath expression) is made up of a series of steps. A step specifies: a) an axis that specifies a direction of traversal in a hierarchical document; b) a node test that selects document nodes along the axis; and c) optionally, a predicate to filter document nodes selected. A node test may be described as identifying a document node with certain features that is to be selected. A predicate may be described as identifying a feature that is used to identify certain document nodes based on a filter.

For example, in FIG. 2, query 240 is an XPath “/a//b[e]//c” in which “/a”, “//b[e]” and “//c” are steps. The “/a” step indicates a child axis (“/”) and the node test selects <a> document nodes. The “//b” step indicates a descendants axis (“//”) and a node test that selects <b> document nodes that satisfy the predicate [e] and that are descendants of the selected <a> document nodes. The “//c” step indicates a descendant axis and the node test selects <c> document nodes that are descendants of the selected <b> document nodes.

The last step of a path is an extraction step. For example, in FIG. 2, “//c” is an extraction step, and <c> document nodes are being extracted from the hierarchical document 200.

Given any step in a path, document nodes in the hierarchical document that are described by that step are called step instances. For example, in FIG. 2, the <a> document node is a step instance because the <a> document node is described by step “/a” of the path. A document node that is described by a step may be described as a “match” for the step.

Each step instance has an associated level. For example, in FIG. 2, the root of the hierarchical document (not shown) is associated with Level 1), the <a> document node is associated with Level 2, the <b> document node is associated with Level 3, etc.

A query structure represents the one or more paths of a query (e.g., represents the XPath or the XPaths of an XQuery For Let Where Return (FLWR) expression). The FOR refers to each document node selected by a location path. The LET refers to a new variable that has a specified value. The WHERE refers to a condition expressed in a path that is true. The RETURN refers to a node set. A FOR binding indicates that nodes in a set of nodes to be returned are returned one at a time (unlike a LET binding for which the set of nodes is returned together with duplicates removed).

When traversing the document nodes of a hierarchical document using depth first traversal, the first time a document node is encountered, that document node is a start event for that document node. For example, if a hierarchical document has multiple <b> document nodes, the first time a first <b> document node is encountered, that first <b> document node is a start event for <b> document nodes. As another example, if an XML document is being streamed using Simple API for XML (SAX), startDocument and startElement events are start events. SAX may be described as an Application Program Interface (API) that enables interpretation of an XML document. For example, in FIG. 2, the <a> document node is a start event.

When all the descendants of a document node have been visited during depth first traversal, the last document node encountered is an end event for that document node. For example, in FIG. 2, the </c> document node is an end event. As another example, an XML document is being streamed using SAX, endDocument and endElement events are end events.

The query processor 130 builds a match graph 140 while finding document nodes of a hierarchical document 134 described by the steps of paths in a query. The query processor later uses the match graph 140 to return results of the query 132.

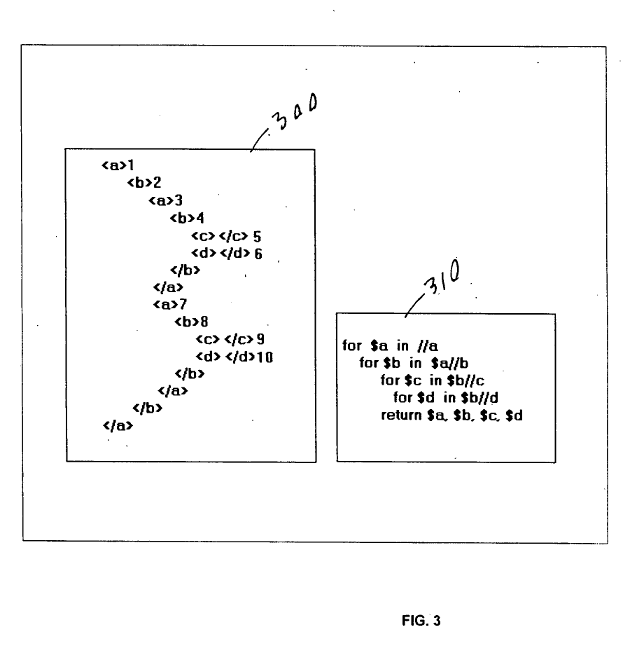

FIG. 3 illustrates a hierarchical document 300 and a query 310 with FOR bindings in accordance with certain embodiments. A match graph 140 is created while the query processor 130 processes start and end events of the hierarchical document 310. The hierarchical document 300 includes instances of the following document nodes: <a>, <b>, <c>, and <d>. The “//a” binding has three step instances, with match identifiers of 1, 3, and 7, respectively. A match identifier may be described as an identifier of a step instance that also identifies a corresponding match node. For example, the match identifier may be a monotonically increasing number that uniquely identifies the step instance and the match node. The “//b” binding has three step instances, with match identifiers of 2, 4, and 8, respectively. The “//c” binding has two step instances, with match identifiers of 5 and 9, respectively. The “//d” binding has two step instances, with match identifiers of 6 and 10, respectively.

Processing of the query 310 returns <a>, <b>, <c>, and <d> documents nodes. That is, one tuple includes <a>, <b>, <c>, and <d> documents nodes.

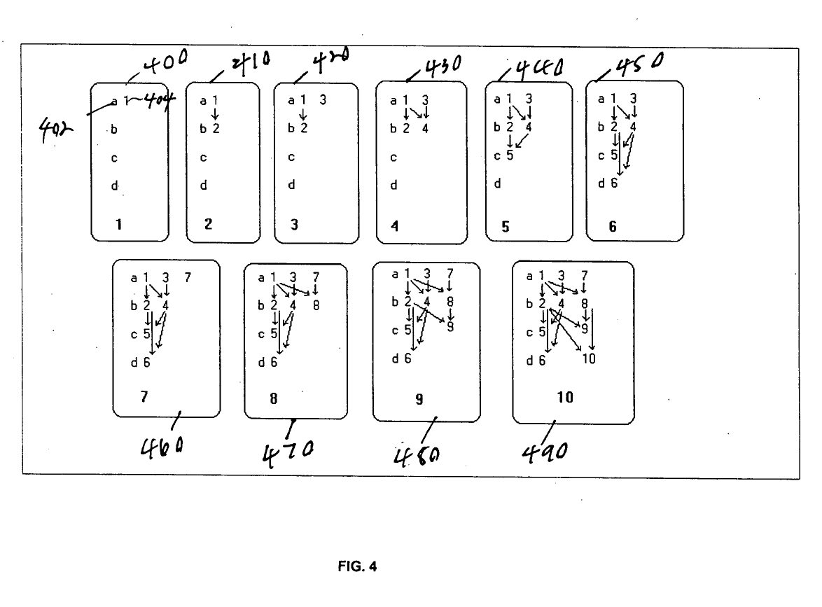

FIG. 4 illustrates building of a match graph in accordance with certain embodiments. In FIG. 4, each panel 400-490 represents a match graph at a certain point in time. Initially, the match graph in panel 400 includes a label for each binding (e.g., a label of “a” for the “//a” binding, a label of “b” for the “//b” binding, a label of “c” for the “//c” binding, and a label of “d” for the “//d” binding), and each binding is associated with a level in the graph (e.g., the “//a” binding is associated with level 1, the “//b” binding is associated with level 2, the “//c” binding is associated with level 3, and the “//d” binding is associated with level 4). With reference to FIG. 4, match identifiers are used to represent match nodes in the match graphs. Each match node is associated with a binding, and so each match identifier is illustrated as associated with a label for a binding. For example, in the match graph in panel 400, “a” 402 is a label for the “//a” binding, and a match node 404 with match identifier 1 is shown near the “a” label because match node 404 is associated with the “//a” binding.

For the match graph in panel 400, the query processor 130 has found a first <a> document node in the hierarchical document 300 described by a node test of a step in the query 310. To indicate the find, the query processor 130 adds match identifier 1 of the <a> step instance (i.e., the document node in the hierarchical document 300 that is described by a step in the query 310) that has been found to represent a match node 770 in the match graph in panel 400.

For the match graph in panel 410, the query processor 130 has found a <b> document node in the hierarchical document 300 described by another node test in a step of the query 310, and the query processor 130 indicates the find by adding match identifier 2 of the <b> step instance that has been found to represent a match node in the match graph in panel 410. The valid ancestor match node for the match node for this <b> step instance with match identifier 2 is the match node for the first <a> step instance, so the query processor 130 adds a forward edge from the match node with match identifier 1 to the match node with match identifier 2. An ancestor match node may be described as a match node at a higher level that points to a match node at a lower level, while a descendant match node is the match node at the lower level that is being pointed to.

For the match graph in panel 420, the query processor 130 has found another <a> document node described by a node test of a step in the query 310, and the query processor 130 adds match identifier 3 of this <a> step instance to represent a match node in the match graph in panel 420.

For the match graph in panel 430, the query processor 130 has found another <b>document node described by a node test in a step of the query, and the query processor adds match identifier 4 of this <b>step instance to the match graph in panel 430. The valid ancestor match nodes for the match node that represents this <b>step instance (i.e., match node with match identifier 4) are the match nodes for the first <a>step instance with match identifier 1 and the second <a>step instance with match identifier 3, so the query processor 130 adds forward edges from match node with match identifier 1 to the match node with match identifier 4 and from the match node with match identifier 3 to the match node with match identifier 4.

For the match graph in panel 440, the query processor 130 has found a <c> document node in the hierarchical document 300 described by a node test in a step of the query 310, and the query processor 130 indicates the find by adding match identifier 5 of the <c>step instance that has been found to represent a match node in the match graph in panel 440. The valid <b>ancestor nodes for the match node for this <c>step instance with match identifier 5 are the match nodes for the previous two <b>step instances with match identifiers 2 and 4, so the query processor 130 adds forward edges from the match nodes with match identifiers 2 and 4 to the match node with match identifier 5.

As the query processor 130 adds forward edges in the graph, the query processor 130 increments an edge count associated with each match node that identifies a step instance. For example, for the match graph in panel 440, the match node with match identifier 5 has an edge count of two because the match node with match identifier 5 is related to the match node with match identifier 2 and the match node with match identifier 4. Similarly, the match node with match identifier 4 has an edge count of three because the match node with match identifier 4 is related to the match node with match identifier 1, the match node with match identifier 3, and the match node with match identifier 5.

Through the match graphs in panels 450-490, the query processor 130 continues matching document nodes and adding forward edges from parent match nodes to child match nodes.

The match graph in panel 490 is the complete match graph for the hierarchical document 300 and the query 310. Once the match graph is created, the query processor 130 generates results by traversing the match graph in panel 490 starting from match nodes associated with lower levels (e.g., the match nodes associated with the “//a” binding at level 1) and following the forward edges of each match node to match nodes in higher levels (e.g., the match nodes associated with the “//d” binding at level 4).

The query processor 130 may revisit match nodes when the query processor 130 finds that an ancestor match node has more than one child per level. For example, with reference to FIG. 4, panel 490, the match graph indicates that the match node with match identifier 2 has two children associated with the “//c” binding in level 3 and two children associated with the “//d” binding in level 4, so the query processor 130 revisits the children in level 4 for every child in level 3.

The step instance and an associated match identifier will be used to indicate traversal of the match graph (e.g., <a>1 indicates that the <a>step instance represented by the match node with match identifier 1 has been traversed). With reference to FIG. 4, panel 490, the query processor 130 starts traversing from <a>1 to <b>2 to <c>5 to <d>6. Now the query processor 130 has the first result: <a>1, <b>2, <c>5, <d>6.

The next <d>step instance to traverse to is <d>10, and the query processor 130 has the second result: <a>1, <b>2, <c>5, <d>10. Since match nodes for both <d>step instances associated with the “//d” binding have been processed with the <a>1, <b>2, <c>5 traversal, the query processor 130 traverses to the match node for the second <c>step instance and revisits the match node for the <d>step instances because the <C>and <d>step instances are still under the same <b>step instance. So the query processor 130 generates the results of <a>1, <b>2, <c>9, <d>6 and <a>1, <b>2, <c>9, <d>10.

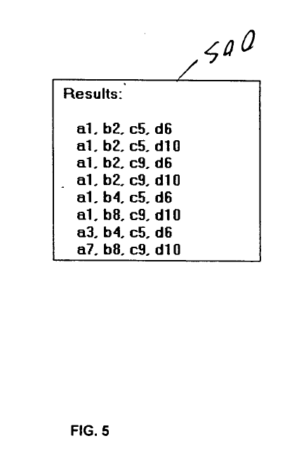

Since both <c>step instances associated with the “//c” binding have been processed with the <a>1, <b>2 traversal, the query processor 130 moves to the next <b>step instance with match identifier 4 and continues the traversal to generate the remaining the results. FIG. 5 illustrates results 500 of processing the query 310 with FOR bindings using a match graph in panel 490 in accordance with certain embodiments.

If there are any predicates which disqualify a step instance, the query processor 130 removes the match node identifying that step instance from the match graph and removes the edges incident to that match node while processing the query and the hierarchical document. While the query processor 130 removes edges, the query processor 130 decrements the edge count associated with each match node that is removed. The query processor 130 also removes match nodes with a zero edge count. In this manner, the query processor 130 avoids traversing to valid match nodes from disqualified match nodes.

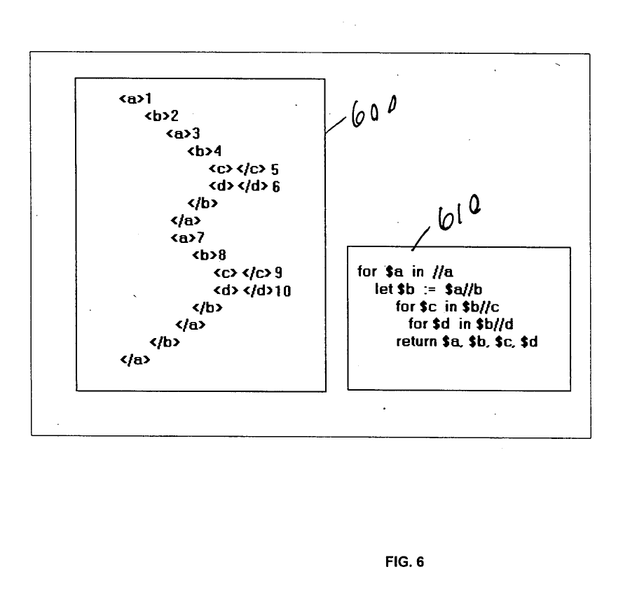

FIG. 6 illustrates a hierarchical document 600 and a query 610 with LET bindings in accordance with certain embodiments. When there are LET bindings in the query 610, the query processor 130 creates LET match nodes in the match graph that remembers the sequences of matches for the LET binding. The hierarchical document 600 includes instances of the following document nodes: <a>, <b>, <c>, and <d>. The “//a” binding has three step instances, with match identifiers of 1, 3, and 7, respectively. The “//b” binding has three step instances, with match identifiers of 2, 4, and 8, respectively. The “//c” binding has two step instances, with match identifiers of 5 and 9, respectively. The “//d” binding has two step instances, with match identifiers of 6 and 10, respectively.

Processing of the query 610 returns <a>, <b>, <c>, and <d>documents nodes. That is, one tuple includes <a>, <b>, <c>, and <d>documents nodes.

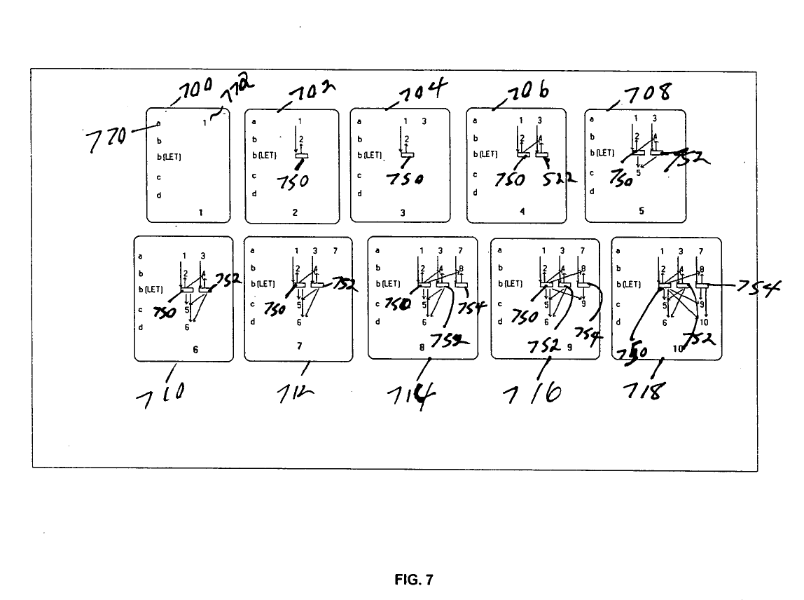

FIG. 7 illustrates building of a match graph with LET match nodes in accordance with certain embodiments. In FIG. 7, each panel 700-718 represents a match graph at a certain point in time. Initially, the match graph in panel 700 includes a label for each binding (e.g., a label of “a” for the “//a” binding, a label of “b” for the “//b” binding, a label of “b(LET)” for the “//b(LET)” binding, a label of “c” for the “//c” binding, and a label of “d” for the “//d” binding), and each binding is associated with a level in the graph (e.g., the “//a” binding is associated with level 1, the “//b” binding is associated with level 2, the “//c” binding is associated with level 3, and the “//d” binding is associated with level 4). In certain embodiments, the level associated with the (LET) binding (e.g., the “//b(LET)” binding) is the lowest level of the match nodes associated with that “//b(LET)” binding. With reference to FIG. 7, match identifiers are used to represent match nodes in the match graphs. Each match node is associated with a binding, and so each match identifier is illustrated as associated with a label for a binding. For example, in the match graph in panel 700, “a” 770 is a label for the “//a” binding, and a match node 772 with match identifier 1 is shown near the “a” label because match node 772 is associated with the “//a” binding.

A LET binding is associated with match nodes to which edges may point and from which edges may point. In the match graph in panel 718, there is a <b>(LET) binding associated with match nodes 750, 752, 754.

For the match graph in panel 700, the query processor 130 has found a first <a>document node in the hierarchical document 600 described by a node test in a step of the query 610. To indicate the find, the query processor 130 adds match identifier 1 of the <a>step instance that has been found to represent a match node in the match graph in panel 700.

For the match graph in panel 702, the query processor 130 has found a <b>document node in the hierarchical document 600 described by another node test in a step of the query 610, and the query processor 130 indicates the find by adding match identifier 2 of the <b>step instance that has been found to represent a match node in the match graph in panel 702. Additionally, a match node 750 is associated with the “//b(LET)” binding and is associated with the match node with match identifier 2. The valid ancestor match node for the match node for this <b>step instance with match identifier 2 is the match node for the first <a>step instance with match identifier 1, so the query processor 130 adds a forward edge from the match node with match identifier 1 to the match node 750 associated with the “//b(LET)” binding and adds a forward edge from this match node 750 to the match node with match identifier 2.

For the match graph in panel 704, the query processor 130 has found another <a>document node that is described by a node test in a step of the query 610, and the query processor 130 adds match identifier 3 of this step instance to represent a match node in the match graph in panel 704.

For the match graph in panel 706, the query processor 130 has found another <b>document node, and the query processor 130 adds match identifier 4 of this step instance to represent a match node in the match graph in panel 706. Also, another match node 752 is added to the match graph in panel 706 and is associated with the match node with match identifier 4. The valid ancestor match nodes for the match node for the <b>step instance with match identifier 4 are the match nodes for the first <a>document with match identifier 1 and the second <a>step instance with match identifier 6, so the query processor 130 adds a forward edge from the match node with match identifier 3 to the added match node 752, adds a forward edge from the match node 750 to the match node with match identifier 4, and adds a forward edge from the match node 752 to the match node with match identifier 4.

For the match graph in panel 708, the query processor 130 has found a <c>document node in the hierarchical document 600 described by a node test in a step of query 610, and the query processor 130 indicates the find by adding match identifier 5 of the <c>step instance that has been found to the match graph in panel 708. The valid <b>ancestor match nodes for the match node for this <c>step instance are the match nodes for the previous two <b>step instances with match identifiers 2 and 4, so the query processor 130 adds forward edges from the match nodes 750, 752 to the match node with match identifier 5.

As the query processor 130 adds forward edges in the graph, the query processor 130 increments an edge count associated with each match node that identifies a step instance. For example, for the match graph in panel 708, the match node with match identifier 5 has an edge count of two because the match node with match identifier 5 is related to the match node with match identifier 2 and the match node with match identifier 4. Similarly, the match node with match identifier 4 has an edge count of three because the match node with match identifier 4 is related to the match node with match identifier 1, the match node with match identifier 6, and the match node with match identifier 5.

Through the match graphs in panels 710-718, the query processor 130 continues matching document nodes and adding forward edges from parent match nodes to child match nodes.

The match graph in panel 718 is the complete match graph for the hierarchical document 600 and the query 610. Once the match graph is created, the query processor 130 generates results by traversing the match graph in panel 718 starting from match nodes in lower levels (e.g., the match nodes associated with the “//a” binding at level 1) and following the forward edges to match nodes in higher levels (e.g., the match nodes associated with the “//d” binding at level 4).

The query processor 130 may revisit step instances when the query processor 130 finds that an ancestor match node has more than one child per level. For example, with reference to FIG. 7, panel 718, the match graph indicates that the match node for the first <b>step instance with match identifier 2 has two children associated with the “//c” binding at level 3 and two children associated with the “//d” binding at level 4, so the query processor 130 revisits the children in level 4 for every child in level 3.

A step instance identified by a match identifier and an associated match identifier will be used to indicate traversal of the match graph (e.g., <a>1 indicates that the <a>step instance with match identifier 1 has been traversed). With reference to FIG. 7, panel 718, the query processor 130 starts traversing from <a>1 to match node 750. From the match node 750, the query processor 130 traverses to <b>2, <b>4, and b<8>. Then, from match node 750, the query processor traverses to <c>5 and to <d>6. Now the query processor 130 has the first result: <a>1, (<b>2, <b>4, b<8>), <c>5, <d>6.

The next <d>step instance to traverse to is <d>10, and the query processor 130 has the second result: <a>1, (<b>2, <b>4, b<8>), <c>5, <d>10. Since the match nodes for both <d>step instances associated with the “//d” binding have been processed with the a>1, <b>2, <c>5 traversal, the query processor 130 traverses to the match node for the second <c>step instance and revisits the match nodes for the <d>step instances because the <c>and <d>step instances are still under the same <b>step instance. So the query processor 130 generates the results of <a>1, (<b>2, <b>4, b<8>), <c>9, <d>6 and a>1, (<b>2, <b>4, b<8>), <c>9, <d>10.

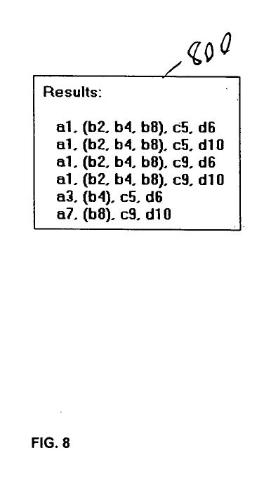

Since match node 750 has been processed, the query processor 130 moves to the next <a>step instance with match identifier 3 and match node 752 and continues the traversal to generate the remaining the results. FIG. 8 illustrates results 800 of processing the query 610 with LET bindings using a match graph in panel 718 in accordance with certain embodiments.

Thus, while the query processor 130 is processing the query 610 and traversing the hierarchical document 600 to identify matching document nodes, for the LET bindings, the edges point to and originate from match nodes (also referred to as LET match nodes) associated with the LET binding, and these LET match nodes then point to individual step instances of a sequence.

Also, with reference to FIG. 7, if there are any predicates which disqualify a step instance, the query processor 130 removes the match node identifying that step instance from the match graph and removes the edges incident to that match node while processing the query and the hierarchical document. While the query processor 130 removes edges, the query processor 130 decrements the edge count associated with each match node that is removed. The query processor 130 also removes match nodes with a zero edge count.

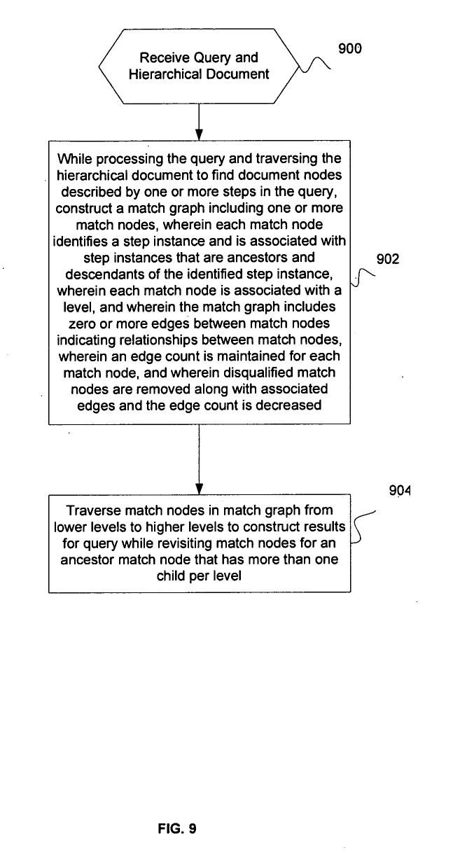

FIG. 9 illustrates logic performed by the query processor 130 in accordance with certain embodiments. Control begins at block 900 with the query processor 130 receiving a query 132 and a hierarchical document 134. In block 902, while processing the query 132 and traversing the hierarchical document 134 to find document nodes described by one or more steps in the query, the query processor 130 constructs a match graph 140 including one or more match nodes. Each match node identifies a step instance and is associated with step instances (represented by other match nodes) that are ancestors and descendants of the identified step instance. Each match node is associated with a level. Also, the match graph 140 includes zero or more edges between match nodes indicating relationships between the match nodes. The query processor 130 maintains an edge count for each match node. Additionally, the query processor 130 removes disqualified match nodes along with associated edges and decreases the edge count based on the removed edges. In certain embodiments, the match graph 140 includes a label for each binding in the query 132, and each match node is associated with a binding. In block 904, the query processor 130 traverses match nodes in the match graph 140 from lower levels to higher levels to construct results for the query 132, while revisiting match nodes for an ancestor match node that has more than one child per level.

### Additional Embodiment Details

The described operations may be implemented as a method, computer program product or apparatus using standard programming and/or engineering techniques to produce software, firmware, hardware, or any combination thereof.

Each of the embodiments may take the form of an entirely hardware embodiment, an entirely software embodiment or an embodiment containing both hardware and software elements. The embodiments may be implemented in software, which includes but is not limited to firmware, resident software, microcode, etc.

Furthermore, the embodiments may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

The described operations may be implemented as code maintained in a computer-usable or computer readable medium, where a processor may read and execute the code from the computer readable medium. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a rigid magnetic disk, an optical disk, magnetic storage medium (e.g., hard disk drives, floppy disks, tape, etc.), volatile and non-volatile memory devices (e.g., a random access memory (RAM), DRAMs, SRAMs, a read-only memory (ROM), PROMs, EEPROMs, Flash Memory, firmware, programmable logic, etc.). Current examples of optical disks include compact disk-read only memory (CD-ROM), compact disk-read/write (CD-R/W) and DVD.

The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

A computer program product may comprise computer useable or computer readable media, hardware logic, and/or transmission signals in which code may be implemented. Of course, those skilled in the art will recognize that many modifications may be made to this configuration without departing from the scope of the embodiments, and that the computer program product may comprise any suitable information bearing medium known in the art.

The term logic may include, by way of example, software, hardware, firmware, and/or combinations of software and hardware.

Certain implementations may be directed to a method for deploying computing infrastructure by a person or automated processing integrating computer-readable code into a computing system, wherein the code in combination with the computing system is enabled to perform the operations of the described implementations.

The logic of FIG. 9 describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

The illustrated logic of FIG. 9 may be implemented in software, hardware, programmable and non-programmable gate array logic or in some combination of hardware, software, or gate array logic.

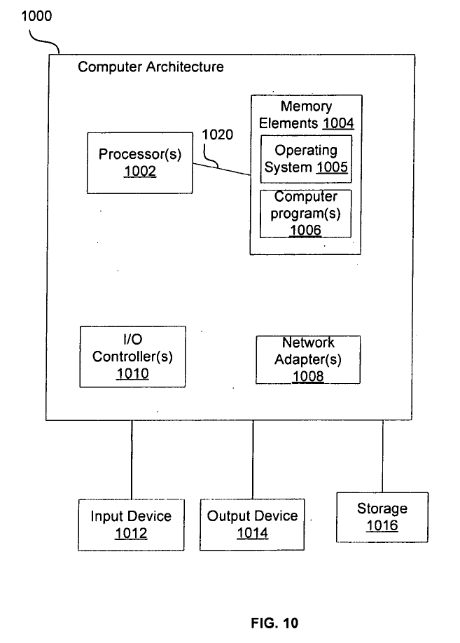

FIG. 10 illustrates a system architecture 1000 that may be used in accordance with certain embodiments. Client computer 100 and/or server computer 120 may implement system architecture 1000. The system architecture 1000 is suitable for storing and/or executing program code and includes at least one processor 1002 coupled directly or indirectly to memory elements 1004 through a system bus 1020. The memory elements 1004 may include local memory employed during actual execution of the program code, bulk storage, and cache memories which provide temporary storage of at least some program code in order to reduce the number of times code must be retrieved from bulk storage during execution. The memory elements 1004 include an operating system 1005 and one or more computer programs 1006.

Input/Output (I/O) devices 1012, 1014 (including but not limited to keyboards, displays, pointing devices, etc.) may be coupled to the system either directly or through intervening I/O controllers 1010.

Network adapters 1008 may also be coupled to the system to enable the data processing system to become coupled to other data processing systems or remote printers or storage devices through intervening private or public networks. Modems, cable modem and Ethernet cards are just a few of the currently available types of network adapters 1008.

The system architecture 1000 may be coupled to storage 1016 (e.g., a non-volatile storage area, such as magnetic disk drives, optical disk drives, a tape drive, etc.). The storage 1016 may comprise an internal storage device or an attached or network accessible storage. Computer programs 1006 in storage 1016 may be loaded into the memory elements 1004 and executed by a processor 1002 in a manner known in the art.

The system architecture 1000 may include fewer components than illustrated, additional components not illustrated herein, or some combination of the components illustrated and additional components. The system architecture 1000 may comprise any computing device known in the art, such as a mainframe, server, personal computer, workstation, laptop, handheld computer, telephony device, network appliance, virtualization device, storage controller, etc.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the embodiments, the embodiments reside in the claims hereinafter appended or any subsequently-filed claims, and their equivalents.

What is claimed is:

1. A computer-implemented method for processing a query, comprising:
receiving the query, wherein the query is formed by one or more paths, and wherein each path includes one or more steps;
receiving a hierarchical document including one or more document nodes; and
while processing the query and traversing the hierarchical document to find document nodes described by at least one of the one or more steps of the query, constructing a match graph including one or more match nodes, wherein each of the match nodes identifies a step instance and is associated with step instances that are ancestors and descendants of the identified step instance, wherein each of the match nodes is associated with a level, and wherein the match graph includes zero or more edges between the match nodes indicating relationships between the match nodes; and
traversing the match nodes in the match graph from lower levels to higher levels to construct results for the query.

2. The method of claim 1, further comprising:
adding a label to the match graph for each binding in the query, wherein each of the match nodes is associated with a binding.

3. The method of claim 2, further comprising:
adding a label to the match graph for a LET binding, wherein each LET binding is associated with one or more LET match nodes and wherein edges point to and originate from the one or more LET match nodes.

4. The method of claim 1, further comprising:
maintaining an edge count for each of the match nodes, wherein the edge count identifies a number of ancestors and descendants associated with an associated step instance.

5. The method of claim 1, further comprising:
removing at least one disqualified match node and edges associated with the at least one disqualified match node; and
decreasing an edge count associated with the at least one disqualified match node.

6. The method of claim 1, wherein the traversing further comprises:
revisiting the match nodes for an ancestor match node that has more than one child at a specified level.

7. A computer program product for processing a query comprising a computer useable medium including a computer readable program, wherein the computer readable program when executed on a computer causes the computer to:
receive the query, wherein the query is formed by one or more paths, and wherein each path includes one or more steps;
receive a hierarchical document including one or more document nodes; and
while processing the query and traversing the hierarchical document to find document nodes described by at least one of the one or more steps of the query, construct a match graph including one or more match nodes, wherein each of the match nodes identifies a step instance and is associated with step instances that are ancestors and descendants of the identified step instance, wherein each of the match nodes is associated with a level, and wherein the match graph includes zero or more edges between the match nodes indicating relationships between the match nodes; and
traverse the match nodes in the match graph from lower levels to higher levels to construct results for the query.

8. The computer program product of claim 7, wherein the computer readable program when executed on a computer causes the computer to:
add a label to the match graph for each binding in the query, wherein each of the match nodes is associated with a binding.

9. The computer program product of claim 8, wherein the computer readable program when executed on a computer causes the computer to:
add a label to the match graph for a LET binding, wherein each LET binding is associated with one or more LET match nodes and wherein edges point to and originate from the one or more LET match nodes.

10. The computer program product of claim 7, wherein the computer readable program when executed on a computer causes the computer to:
maintain an edge count for each of the match nodes, wherein the edge count identifies a number of ancestors and descendants associated with an associated step instance.

11. The computer program product of claim 7, wherein the computer readable program when executed on a computer causes the computer to:
remove at least one disqualified match node and edges associated with the at least one disqualified match node; and
decrease an edge count associated with the at least one disqualified match node.

12. The computer program product of claim 7, wherein when traversing, the computer readable program when executed on a computer causes the computer to:
revisit the match nodes for an ancestor match node that has more than one child at a specified level.

13. A system for processing a query, comprising:
logic capable of performing operations, the operations comprising:
receiving the query, wherein the query is formed by one or more paths, and wherein each path includes one or more steps;
receiving a hierarchical document including one or more document nodes; and
while processing the query and traversing the hierarchical document to find document nodes described by at least one of the one or more steps of the query, constructing a match graph including one or more match nodes, wherein each of the match nodes identifies a step instance and is associated with step instances that are ancestors and descendants of the identified step instance, wherein each of the match nodes is associated with a level, and wherein the match graph includes zero or more edges between the match nodes indicating relationships between the match nodes; and
traversing the match nodes in the match graph from lower levels to higher levels to construct results for the query.

14. The system of claim 13, wherein the operations further comprise:
adding a label to the match graph for each binding in the query, wherein each of the match nodes is associated with a binding.

15. The system of claim 14, wherein the operations further comprise:
adding a label to the match graph for a LET binding, wherein each LET binding is associated with one or more LET match nodes and wherein edges point to and originate from the one or more LET match nodes.

16. The system of claim 13, wherein the operations further comprise:
maintaining an edge count for each of the match nodes, wherein the edge count identifies a number of ancestors and descendants associated with an associated step instance.

17. The system of claim 13, wherein the operations further comprise:
removing at least one disqualified match node and edges associated with the at least one disqualified match node; and
decreasing an edge count associated with the at least one disqualified match node.

18. The system of claim 13, wherein the operations for traversing further comprise:
revisiting the match nodes for an ancestor match node that has more than one child at a specified level.
